(19) United States
(12) Patent Application Publication
(10) Pub. No.: US 2007/0147747 A1
(43) Pub. Date: Jun. 28, 2007

(54) Optical module and optical transmission system using the same

(75) Inventors: Takayoshi Inujima, Kanagawa-ken (JP); Mikihiko Kato, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/645,563

(22) Filed: Dec. 27, 2006

(30) Foreign Application Priority Data
Dec. 27, 2005 (JP) 2005-374518

(51) Int. Cl. G02B 6/36

(52) U.S. Cl. 385/92; 385/88

(57) ABSTRACT

The lead can be short in length, whereby the optical module can response at high speed. An optical module is provided with an optical element mounted on a lead frame and is mounted on a substrate by way of the lead frame. The optical element is mounted so that its optical axis intersects the surface of the substrate in a state where the optical module is mounted on the substrate, and a deflector which deflects the optical path of light propagating along the optical axis of the optical element is provided.

### BACKGROUND OF THE INVENTION

1. Field of the Invention

This invention relates to an optical module having a light receiving element or a light emitting element on a lead frame to be mounted on a board. This invention further relates to an optical transmission system using such an optical module.

2. Description of the Related Art

As shown in Japanese Unexamined Patent Publication Nos. 2005-099769 or 2003-279809, there has been known an optical module comprising a member which is provided with alight receiving element or a light emitting element and which is to be mounted on a board. The optical modules of the kinds include one or both of the light receiving element and the light emitting element have been known, and they have been put into wide use in the field of optical communication. In the field of the optical communication, recently, there has been an increasing demand for a miniaturized high speed optical module, and especially a high speed optical module which is in the order of several Gbps (giga bits/second) in transmission speed is required.

When the optical modules to be used to the application described above are divided on the basis of their structures, the optical modules where the optical element is accommodated in a can type package as shown in Japanese Unexamined Patent Publication No. 2005-099769 and the optical modules where the optical element is enclosed in transparent molded resin as shown in Japanese Unexamined Patent Publication No. 2003-279809 are well known.

However, there have been problems in the optical module of the type disclosed in Japanese Unexamined Patent Publication No. 2005-099769 that the response speed is limited by an capacity parasitic on the package and an inductance of the lead and that miniaturization is limited since the package is relatively large in size.

On the other hand, in the optical module of the type disclosed in Japanese Unexamined Patent Publication No. 2003-279809, the lead is apt to be long when it corresponds to the general form of use in the field of optical communication. Accordingly, there has been a problem also in the optical module of the type disclosed in Japanese Unexamined Patent Publication No. 2003-279809 that the response speed is limited by an inductance of the lead. This point will be described in further detail, hereinbelow.

In the filed of the optical communication, in many cases, the optical module is mounted on a flat board, an optical fiber is disposed so that an end portion thereof is held substantially parallel to the flat board and a connector connected to the end portion of the optical fiber is connected to a receptacle of the optical module. In this case, when the connector is above the flat board, the core axis of the optical fiber is positioned at a level at least equal to a half of the vertical size of the connector from the surface of the board. To optically connect the optical element of the optical module with the optical fiber at such a level, it is necessary to dispose the optical element so that its optical axis is aligned with the core axis of the optical fiber with the optical axis being directed in parallel to the surface of the board. The distance between the surface of the board is increased for this purpose, and accordingly, the length of the lead is increased according thereto.

### SUMMARY OF THE INVENTION

In view of the foregoing observations and description, the primary object of the present invention is to provide an optical module which can be small in the length of the lead, whereby a high-speed response can be realized.

Another object of the present invention is to provide an optical transmission system which can transmit an optical signal at high speed.

The optical module of the present invention is characterized in that the length of the lead can be small in the length by deflecting an optical path of light emitted from the optical element (in this case, the optical element is a light emitting element) or an optical path of light to the optical element (in this case, the optical element is a light receiving element). Specifically, in accordance with the present invention, there is provided an optical module which is provided with an optical element mounted on a lead frame and is mounted on a substrate by way of the lead frame, characterized in that

the optical element is mounted so that its optical axis intersects the surface of the substrate in a state where the optical module is mounted on the substrate, and

a deflecting means which deflects the optical path of light propagating along the optical axis of the optical element is provided.

As the deflecting means, a mirror which folds the optical path may be suitably employed.

It is preferred that the optical element be mounted so that its optical axis is substantially in perpendicular to the surface of the substrate in a state where the optical module is mounted on the substrate, and the deflecting means substantially perpendicularly deflects the optical path of light propagating along the optical axis of the optical element.

Further, it is preferred that at least a part of the lead frame and the optical element be enclosed in a transparent resin package.

Further, it is preferred that when such a transparent resin package is applied, a part of the lead frame be exposed from the transparent resin package to form a lead.

Further, it is preferred that when a transparent resin package described above is applied, reflecting film be formed on a side of the transparent resin package to form a mirror as the deflecting means.

Further, it is preferred that when a transparent resin package described above is applied, a lens portion for diffracting light to or from the optical element be formed in a part of the transparent resin package.

Further, it is preferred that when a transparent resin package described above is applied, a part of the transparent resin package which forms an incident end face of light impinging upon the optical element be an inclined surface inclined to the direction of travel of the light.

Further, it is preferred that the optical module of the present invention be formed as a surface mounting type.

It is preferred that the optical module of the present invention be provided with an integrated circuit related to drive of the optical element on the side of the lead frame opposite to the side on which the optical element is mounted.

Further, it is preferred that the optical module of the present invention be provided with both a light emitting element and a light receiving element as the optical element.

In accordance with the present invention, there is further provided a first optical transmission system comprising an optical module of the present invention described above, and

an optical fiber optically connecting the optical element to another optical element external of the optical element.

In accordance with the present invention, there is further provided a second optical transmission system comprising

a first optical module which is of the present invention described above and is provided with at least one light emitting element as the optical element,

a second optical module which is of the present invention described above and is provided with at least one light receiving element as the optical element, and

an optical fiber optically connecting the light emitting element of the first optical module to the light receiving element of the second optical module.

The optical module of the present invention is free of the above problem generated in use of the can type package, that is, the response speed is limited by an capacity parasitic on the package and an inductance of the lead and that miniaturization is limited, since the optical element is not accommodated in the package.

Further, since, in the optical module of the present invention, the optical element is mounted so that its optical axis intersects the surface of the substrate in a state where the optical module is mounted on the substrate, and a deflecting means such as a mirror which deflects the optical path of light propagating along the optical axis of the optical element is provided, the problem that the length of the lead is increased is prevented even if the optical fiber is disposed to extend substantially in parallel to the substrate surface and the optical fiber is disposed at a distance from the substrate surface.

That is, when a case where light emitted from the optical fiber is caused to enter the light receiving element of the optical module is described by way of example for the purpose of simplicity, light emitted from the optical fiber to travel substantially parallel to the substrate surface can be guided to the light receiving element of the optical module by folding it by the light deflecting means such as a mirror. If so, it is unnecessary to position the light receiving element high above the substrate surface to be opposed to the core of the optical fiber, and accordingly, the lead can be short independently of the level of the optical fiber. When the lead can be short, the inductance of the lead can be small, whereby a high response speed can be realized. In the case of causing light emitted from the light emitting element of the optical module to enter the core of the optical fiber, the same situation occurs and the light emitted from the light emitting element of the optical module can be guided to the core of the optical fiber, for instance, by reflecting the light by a mirror as the light deflecting means even if the lead of the light emitting element is short and the light emitting element is disposed at a relatively short distance from the substrate surface. Also in this case, a high response speed can be realized by making the lead short and the inductance of the lead small.

When the optical element is mounted so that its optical axis is substantially in perpendicular to the surface of the substrate in a state where the optical module is mounted on the substrate, and the deflecting means substantially perpendicularly deflects the optical path of light propagating along the optical axis of the optical element, light deflected by the deflecting means can be caused to impinge upon the end face of the optical fiber in perpendicular thereto or light emitted from the end face of the core of the optical fiber can be caused to impinge upon the light receiving element of the optical module in perpendicular thereto in the case the optical fiber is disposed to extend in parallel to the surface of the substrate as in the usual manner.

When at least a part of the lead frame and the optical element are enclosed in a transparent resin package, the lead frame and the optical element can be protected by the transparent resin package.

When such a transparent resin package is applied, and a part of the lead frame is exposed from the transparent resin package to form a lead, a major part of the lead frame can be protected by the transparent resin package.

When a transparent resin package described above is applied, and reflecting film is formed on a side of the transparent resin package to form a mirror as the deflecting means, the reliability of the optical module can be increased since structure is simplified as compared with the case where the mirror is separately formed.

When a transparent resin package described above is applied and a lens portion for diffracting light to or from the optical element is formed in a part of the transparent resin package, the reliability of the optical module can be increased since structure is simplified as compared with the case where a lens of the type is separately formed, for instance, for collecting light.

When a transparent resin package described above is applied, and a part of the transparent resin package which forms an incident end face of light impinging upon the optical element is an inclined surface inclined to the direction of travel of the light, the light reflected at the end face cannot return to the light source such as a semiconductor laser reversely along the previous optical path to generate so-called return light noise since it is reflected in a direction deviated from the previous optical path.

When the optical module of the present invention is of a surface mounting type, the inductance of the lead can be further reduced, which is further preferred in view of realizing a high response speed.

When an integrated circuit related to drive the optical element is mounted on the side of the lead frame opposite to the side on which the optical element is mounted, the degree of freedom of the layout of the integrated circuit or the optical element is increased. Further, though the integrated circuit of the type can be a noise source to the optical element, the noise which the optical element receives can be reduced by so mounting the integrated circuit.

Though the optical module of the present invention may be provided with only one of a light emitting element and a light receiving element, when it is provided with both a light emitting element and a light receiving element, a transmission system and a receiving system of an optical communicating system can be formed by only a single of the optical module, which can be said to be more preferred.

In the first optical transmission system of the present invention, the optical transmission can be performed at a high speed since the optical module of the present invention is employed.

In the second optical transmission system of the present invention, the optical transmission can be performed at a higher speed since the optical module of the present invention is employed as an optical module connected to each end of an optical fiber.

### BRIEF DESCRIPTION OF THE DRAWINGS

FIG. 1 is a perspective view showing an optical module in accordance with a first embodiment of the present invention,

FIG. 2 is a side view of the optical module,

FIG. 3 is a plan view of the optical module,

FIG. 4 is a side view showing an optical module in accordance with a second embodiment of the present invention,

FIG. 5 is a side view showing an optical module in accordance with a third embodiment of the present invention,

FIG. 6 is a side view showing an optical module in accordance with a fourth embodiment of the present invention,

FIG. 7 is a side view showing an optical module in accordance with a fifth embodiment of the present invention, and

FIG. 8 is a plan view showing an optical module in accordance with a sixth embodiment of the present invention.

### DESCRIPTION OF THE PREFERRED EMBODIMENTS

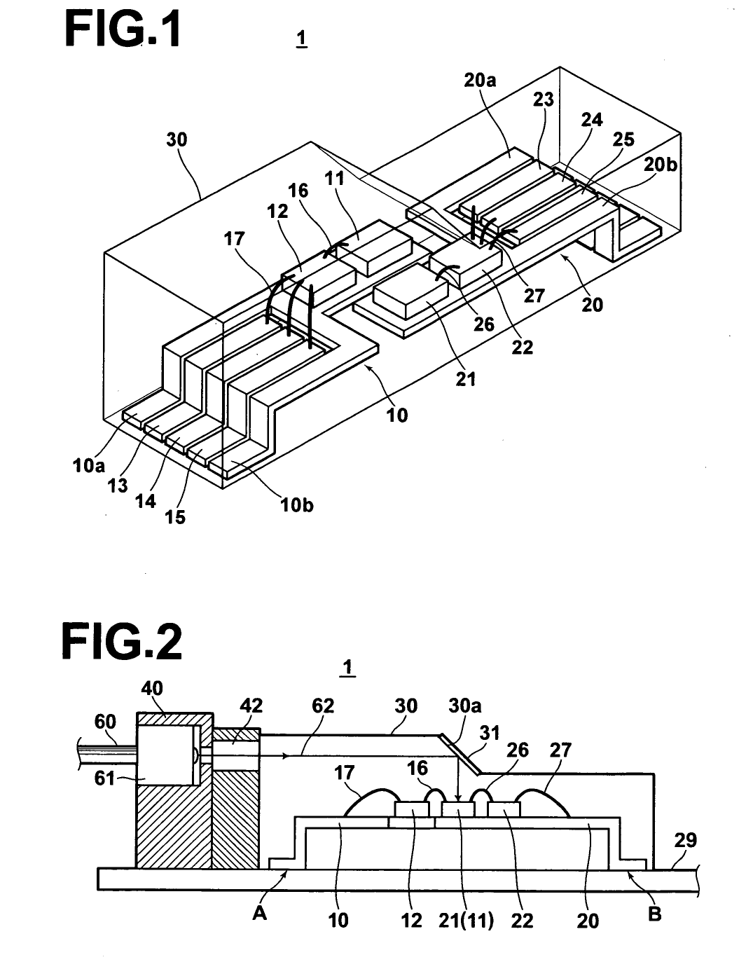

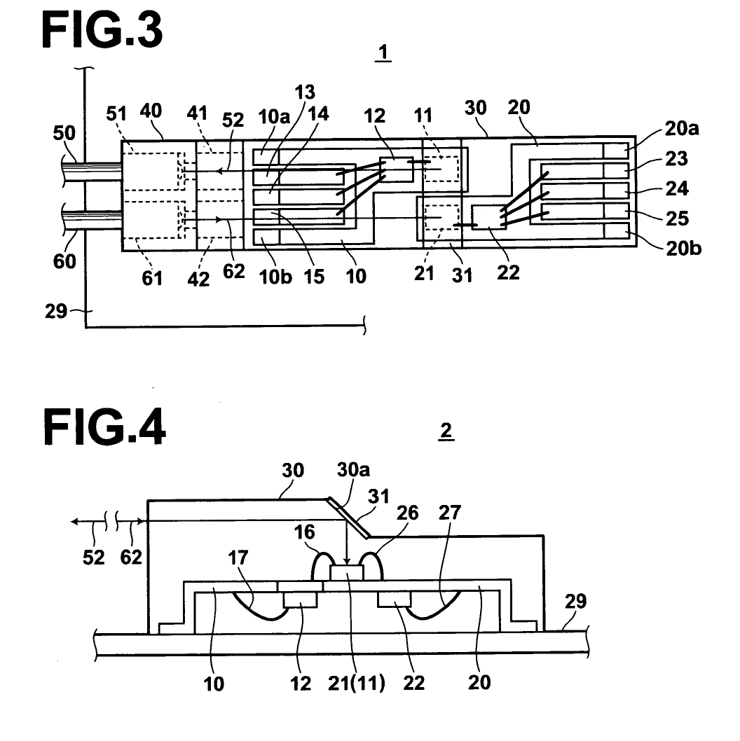

FIG. 1 shows in perspective an optical module 1 in accordance with the first embodiment of the present invention, and FIGS. 2 and 3 respectively show a side shape and a plan shape of the optical module 1. As shown in FIG. 1, the optical module 1 of this embodiment comprises a pair of lead frames 10 and 20 which are formed of conductive material such as cupper and have a thinned tip portion. A light emitting element 11 such as a laser diode and an IC (integrated circuit) 12 for driving the light emitting element are mounted on an upper surface of the tip portion of one 10 of the lead frames, and a light receiving element 21 such as a photodiode and an IC (integrated circuit) 22 for driving the light receiving element are mounted on an upper surface of the tip portion of the other 20 of the lead frames.

On the other hand, the lead frame 10 has a U-shaped base end portion, that is, the base end portion is bifurcated into a pair of base end portions 10a and 10b and three (for instance) leads 13, 14, and 15 are disposed in the base end portion. The base end portions 10a and 10b of the lead frame 10 themselves also form the lead. Similarly, the other lead frame 20 has a U-shaped base end portion, that is, the base end portion is bifurcated into a pair of base end portions 20a and 20b and three (for instance) leads 23, 24, and 25 are disposed in the base end portion. The base end portions 20a and 20b of the lead frame 20 themselves also form the lead.

The light emitting element 11 is connected to the IC 12 by way of a wire 16 and the IC 12 is connected to the leads 13, 14, and 15 by way of the wire 17. The light receiving element 21 is connected to the IC 22 by way of a wire 26 and the IC 22 is connected to the leads 23, 24, and 25 by way of the wire 27.

Each of the elements described above is enclosed in a transparent resin package 30 in the form of a block. Though only the leads 13 to 15 and the lower surfaces of the base end portions 10a and 10b (indicated by arrow A in FIG. 2) as well as the leads 23 to 25 and the lower surfaces of the base end portions 20a and 20b (indicated by arrow B in FIG. 2) are, the other part of the lead are perfectly enclosed in the transparent resin package 30 together with other elements.

The transparent resin package 30 is provided with an inclined surface 30a which is inclined by 45° to the upper surfaces of the lead frames 10 and 20 in a position opposed to the light emitting element 11 and the light receiving element 21. A mirror 31 is formed on the inclined surface 30a, for instance, by depositing metal.

Operation of the optical module 1 having structure described above will be described, hereinbelow. The optical module 1 is mounted on a surface of a flat board 29 as shown in FIG. 2. In this case, the leads 13 to 15 and the lower surfaces of the base end portions 10a and 10b which are exposed from the transparent resin package 30 as described above are, for instance, soldered to a predetermined circuit component of the board 29. When the leads 13 to 15 and the lower surfaces of the base end portions 10a and 10b are to be soldered, it is preferred that the transparent resin package 30 be formed by a material resistant to the heat applied to melt the solder.

As shown in FIGS. 2 and 3, a receptacle 40 which can mate with two connectors, a collecting lens 41 which may comprise, for instance, refractive index profile type lens and is interposed between the receptacle 40 and the optical module 1, and a collimator lens 42 which may comprise, for instance, refractive index profile type lens and is interposed between the receptacle 40 and the optical module 1 are fixed on the board 29. A connector 51 connected to one end of one optical fiber 50 and another connector 61 connected to one end of another optical fiber 60 are mated with the receptacle 40.

The other end of said optical fiber 60 is optically connected to a light emitting element such as a laser diode (not shown) and light emitted from the light emitting element propagates the core of the optical fiber 60. The light 62 thus propagating the core of the optical fiber 60 is emitted from said one end of the optical fiber 60 held by the connector 61 as divergent light and then is made parallel by the collimator lens 42, and then enters the transparent resin package 30. Since said one end of the optical fiber 60 is in parallel to the surface of the board 29, the light emitted from the optical fiber 60 travels in a direction parallel to the surface of the board 29.

Light 62 traveling through the transparent resin package 30 is folded by 90° in its optical path by the mirror 31 to travel downward, that is, in a direction perpendicular to the surface of the board 29 and received by the light receiving element 21. In FIG. 2, travel of light 62 is shown.

Whereas, light (a laser beam) 52 is emitted upward, that is, in a direction perpendicular to the surface of the board 29, from the light emitting element 11. The light 52 is folded by 90° in its optical path by the mirror 31 to travel in a direction parallel to the surface of the board 29 and emitted from the transparent resin package 30. The light 52 emitted from the transparent resin package 30 is collected by the collecting lens 41 and enters the core of the optical fiber 50 from one end of the optical fiber 50. The light 52 propagates through the optical fiber 50 and is received by the light receiving element (not shown) connected to the other end of the optical fiber 50. If necessary, a collimator lens which makes parallel the light 52 emitted from the light emitting element 11 may be disposed in the transparent resin package 30.

Thus the optical module 1 of this embodiment forms a part of an optical transmission system which transmits the light 52 emitted from the light emitting element 11 to the light receiving element outside the optical module 1 of this embodiment by way of the optical fiber 50, and transmits the light 62 emitted from the light emitting element outside the optical module 1 of this embodiment to the light receiving element 21 by way of the optical fiber 60. In this case, when the light 52 is modulated, for instance, by directly driving the light emitting element 6 to modulate it, information can be transmitted. When the light 62 has been modulated, the optical module 1 can receive information carried by the light 62. Thus, a transceiver can be formed by the optical module 1.

It is possible to form on optical transmission system by connecting the optical modules similar to those 1 of the present invention to the other ends of the optical fibers 50 and 60. In such a case, a light emitting element 11 is connected to one end of the optical fiber 50 while a light receiving element 21 is connected to the other end of the optical fiber 50, and a light receiving element 21 is connected to one end of the optical fiber 60 while a light emitting element 11 is connected to the other end of the optical fiber 60.

The optical module 1 of this embodiment is free of the above problem generated in use of the can type package, that is, the response speed is limited by an capacity parasitic on the package and an inductance of the lead and that miniaturization is limited, since the optical element 1 of this embodiment is not accommodated in the package.

In the optical module 1 of this embodiment, since the light emitting element 11 and the light receiving element 21 are substantially in perpendicular to the surface of the board 29 in a state where the optical module 1 is mounted on the board 29 and at the same time, a mirror 31 which folds by 90° the optical path of light 52 or 62 which travels along the optical axis is provided, the problem that the leads 13 to 15 and 10a and 10b, and the leads 23 to 25 and 20a and 20b are increased in their lengths when an optical fiber 50 or 60 which is substantially parallel to the surface of the board 29 in its one end portion is at a distance from the substrate surface can be avoided.

That is, when the optical path of the light 52 or 62 is folded by a mirror 31, it is unnecessary to position the light emitting element 11 and the light receiving element 21 high above the substrate surface to be opposed to the core of the optical fibers 50 and 60, and accordingly, the leads 13 to 15 and 10a and 10b and the leads 23 to 25 and 20a and 20b can be short irrespectively of the level of the optical fibers 50 and 60. When the lead can be short, the inductance of the lead can be small, whereby a high response speed can be realized.

Accordingly, the above optical transmission system formed by combining one or more such optical modules 1 with optical fibers can perform the optical transmission at high speed.

In the optical module 1 of this embodiment, since the lead frames 10 and 20, the leads 13 to 15 and 23 to 25, the light emitting element 11 and the light receiving element 21 are enclosed in a transparent resin package 30, all the components can be protected by the transparent resin package 30.

Especially, in this embodiment, since apart of the lead frames 10 and 20 and the leads 13 to 15 and 23 to 25 is exposed from the transparent resin package 30, a major part of these components can be effectively protected by the transparent resin package 30.

Further, in this embodiment, since the lead frames 10 and 20 are surface mounting types, the inductance of the lead can be further reduced, which is advantageous in realizing a high response speed.

Further, in this embodiment, since reflecting film is formed on a side 30a of the transparent resin package 30 to form a mirror 30, the reliability of the optical module 1 can be increased since structure is simplified as compared with the case where the mirror 31 is separately formed.

The mirror is not limited to such a form but may be formed, for instance, by fixing a member having reflecting film to a side 30a of the transparent resin package 30. It is possible to cause the optical module 1 to have a wavelength selectivity by employing photonic structure in the mirror 31.

By protecting the light emitting element 11 and/or the light receiving element 21 by a means such as a potting resin not to directly contact with the transparent resin package 30, the reliability of the optical module 1 can be increased.

A second embodiment of the present invention will be described with reference to FIG. 4, hereinbelow. In FIG. 4, the elements analogous to those shown in FIGS. 1 to 3 are given same reference numerals and will not be described unless necessary. (the same in the following Figures)

In the optical module 2 of the second embodiment, an IC 12 is mounted on the side of the lead frame 10 opposite to the side on which the light emitting element 11 is mounted, and an IC 22 is mounted on the side of the lead frame 20 opposite to the side on which the light emitting element 22 is mounted. With this arrangement, the degree of freedom of the layout of the ICs 12 and 22 and/or the light emitting element 11 and the light receiving element 21 is increased. Further, though the ICs 12 and 22 can be a noise source to the light emitting element 11 and the light receiving element 21, the noise which the light emitting element 11 and the light receiving element 21 receive can be reduced by so mounting the ICs 12 and 22.

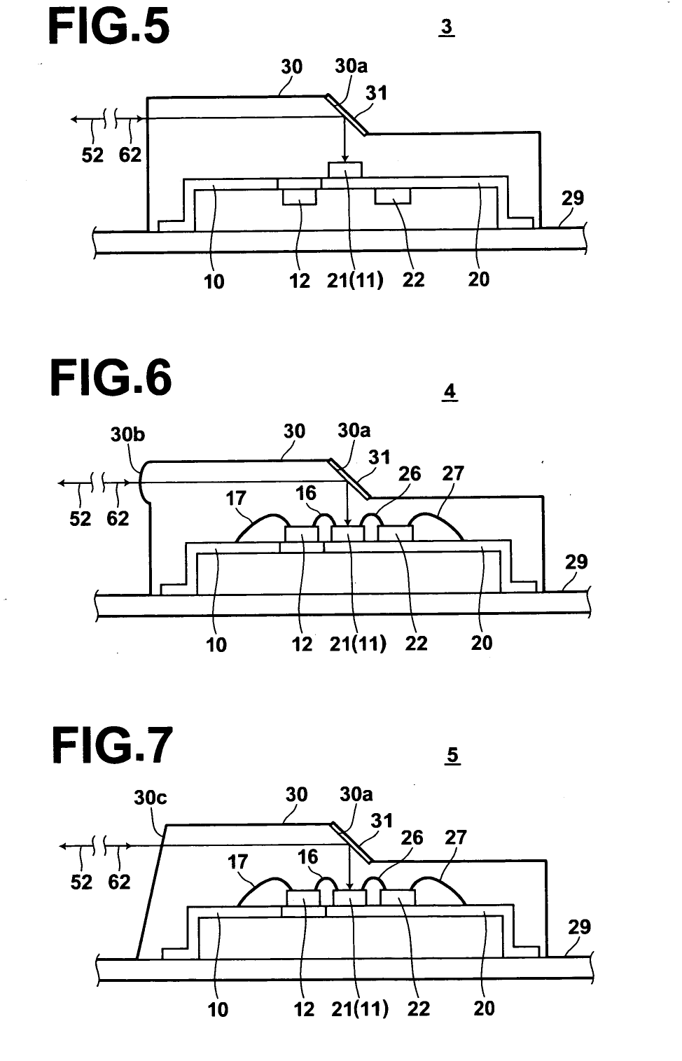

A third embodiment of the present invention will be described with reference to FIG. 5, hereinbelow. The optical module 3 of the third embodiment is the same as the second embodiment in the structure of the element but differs from that in that the ICs 12 and 22 or the light emitting element 11 and the light receiving element 21 are mounted by a method other than wiring, for instance, by brazing or soldering. By employing such a method of mounting, the inductance of the wire can be reduced, whereby a further high-speed transmission can be realized.

A fourth embodiment of the present invention will be described with reference to FIG. 6, hereinbelow. The optical module 4 of the fourth embodiment is the same as the first embodiment in the basic structure but the surface of the transparent resin package 30 forms a lens surface 30b in the portion from which the light 52 emits or the light 62 enters. By employing such structure, light can be collected or made parallel without adding to man-hour or cost as in the case where an outer lens is provided. Further, the structure can be simplified and the reliability is increased as compared with the case where an outer lens is provided.

A fifth embodiment of the present invention will be described with reference to FIG. 7, hereinbelow. The optical module 5 of the fifth embodiment is the same as the first embodiment in the basic structure but the surface of the transparent resin package 30 forms an inclined surface 30c inclined to the direction of travel of light 62 in the portion from which the light 62 enters. By employing such structure, the light reflected at the surface cannot return to the laser diode or the like (which is a light source of the light 62) reversely along the previous optical path since it is reflected in a direction deviated from the previous optical path. Thus it is possible to prevent generation of noise due to such return light.

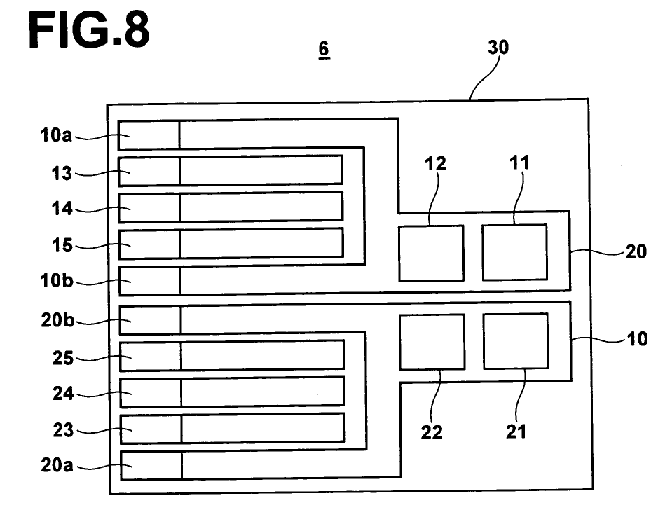

A sixth embodiment of the present invention will be described with reference to FIG. 8, hereinbelow. The optical module 6 of the sixth embodiment is the same as the preceding embodiments in the structure of the element but differs from that in the layout of the elements. That is, though being disposed in the longitudinal direction in the first to fifth embodiments, the lead frames 10 and 20 are disposed in the transverse direction in the sixth embodiment.

Though having both the light emitting element 11 and the light receiving element 21, the optical module of the present invention may be provided with one of the light emitting element 11 and the light receiving element 21.

What is claimed is:

1. An optical module which is provided with an optical element mounted on a lead frame and is mounted on a substrate by way of the lead frame, characterized in that
the optical element is mounted so that its optical axis intersects the surface of the substrate in a state where the optical module is mounted on the substrate, and
a deflecting means which deflects the optical path of light propagating along the optical axis of the optical element is provided.

2. An optical module as defined in claim 1 in which the deflecting means is a mirror which folds the optical path.

3. An optical module as defined in claim 1 in which the optical element is mounted so that its optical axis is substantially in perpendicular to the surface of the substrate in a state where the optical module is mounted on the substrate, and the deflecting means substantially perpendicularly deflects the optical path of light propagating along the optical axis of the optical element.

4. An optical module as defined in claim 1 in which at least a part of the lead frame and the optical element be enclosed in a transparent resin package.

5. An optical module as defined in claim 4 in which a part of the lead frame is exposed from the transparent resin package to form a lead.

6. An optical module as defined in claim 4 in which reflecting film is formed on a side of the transparent resin package to form a mirror as the deflecting means.

7. An optical module as defined in claim 4 in which a lens portion for diffracting light to or from the optical element is formed in a part of the transparent resin package.

8. An optical module as defined in claim 4 in which a part of the transparent resin package which forms an incident end face of light impinging upon the optical element is an inclined surface inclined to the direction of travel of the light.

9. An optical module as defined in claim 1 in which the optical module is formed as a surface mounting type.

10. An optical module as defined in claim 1 in which the optical module is provided with an integrated circuit related to drive of the optical element on the side of the lead frame opposite to the side on which the optical element is mounted.

11. An optical module as defined in claim 1 in which the optical module is provided with both a light emitting element and a light receiving element as the optical element.

12. An optical transmission system comprising
an optical module which is provided with an optical element mounted on a lead frame and is mounted on a substrate by way of the lead frame, and
an optical fiber optically connecting the optical element to another optical element external of the optical element,
characterized in that
the optical element is mounted so that its optical axis intersects the surface of the substrate in a state where the optical module is mounted on the substrate, and
a deflecting means which deflects the optical path of light propagating along the optical axis of the optical element is provided.

13. An optical transmission system as defined in claim 12 in which the deflecting means is a mirror which folds the optical path.

14. An optical transmission system as defined in claim 13 in which the optical element is mounted so that its optical axis is substantially in perpendicular to the surface of the substrate in a state where the optical transmission is mounted on the substrate, and the deflecting means substantially perpendicularly deflects the optical path of light propagating along the optical axis of the optical element.

15. An optical transmission system comprising
a first optical module which is provided with at least a light emitting element mounted on a lead frame and is mounted on a substrate by way of the lead frame,
a second optical module which is provided with at least a light receiving element mounted on a lead frame and is mounted on a substrate by way of the lead frame, and
an optical fiber optically connecting the light emitting element of the first optical module to the light receiving element of the second optical module,
the first optical module being characterized in that
the light emitting element is mounted so that its optical axis intersects the surface of the substrate in a state where the optical module is mounted on the substrate, and a deflecting means which deflects the optical path of light propagating along the optical axis of the optical element is provided and
the second optical module being characterized in that
the light receiving element is mounted so that its optical axis intersects the surface of the substrate in a state where the optical module is mounted on the substrate, and a deflecting means which deflects the optical path of light propagating along the optical axis of the optical element is provided.

16. An optical transmission system as defined in claim 15 in which the deflecting means of each of the first and/or second optical module is a mirror which folds the optical path.

17. An optical transmission system as defined in claim 15 in which the light emitting element of the first optical module is mounted so that its optical axis is substantially in perpendicular to the surface of the substrate in a state where the first optical module is mounted on the substrate, and the deflecting means of the first optical module substantially perpendicularly deflects the optical path of light propagating along the optical axis of the light emitting element.

18. An optical transmission system as defined in claim 15 in which the light receiving element of the second optical module is mounted so that its optical axis is substantially in perpendicular to the surface of the substrate in a state where the second optical module is mounted on the substrate, and the deflecting means of the second optical module substantially perpendicularly deflects the optical path of light propagating along the optical axis of the light receiving element.
